(19) United States
(12) Patent Application Publication
(10) Pub. No.: US 2014/0290051 A1
(43) Pub. Date: Oct. 2, 2014

(54) METHOD OF MANUFACTURING A DATA CARRIER PROVIDED WITH A MICROCIRCUIT

(71) Applicant: Chi Tung Tsoi, Hong Kong (CN)

(72) Inventor: Chi Tung Tsoi, Hong Kong (CN)

(73) Assignee: GEMALTO TECHNOLOGIES ASIA LTD, Hong Kong (CN)

(21) Appl. No.: 14/347,327

(22) PCT Filed: Sep. 28, 2011
(86) PCT No.: PCT/CN2011/080269

§ 371 Date: Jun. 18, 2014

(51) Int. Cl. G06K 19/077

(52) U.S. Cl. CPC G06K 19/077
USPC 29/827

(57) ABSTRACT

The present invention consists to a method of manufacturing a data carrier (1), comprising a data carrier body (3) and a module (5) fixed above a cavity in said data carrier body (3), said method comprising the following steps:—a first step (101) of providing a module (5),—a second step (102) of applying a preformed first layer (31) on the dielectric substrate (53) of said module (5), said first layer (31) having a hole (33) to receive the electronic chip (55), its wires (57) and the dielectric resin protection (59),—a third step (103) of applying a second layer (35) on the first layer (31), recovering the hole (33) of the first layer (35),—a fourth step (104) of laminating of the module (5), the first and second layers (31, 35),—a fifth step (105) of cutting or pre-cutting at the data carrier format.

### TECHNICAL FIELD

The invention concerns a method of manufacturing a data carrier provided with a microcircuit. The data carrier can be, for example, a plug that can be inserted in a cellular phone or any electronic device requiring the identification of the device user for accessing a telecommunication network. The data carrier can be, for example, a Subscriber Identity Module card (SIM card) having the dimensions and shape of a Third Universal Integrated Circuit Card Form Factor (3FF) or of the forthcoming Fourth Universal Integrated Circuit Card Form Factor (4FF).

### DESCRIPTION OF THE RELATED ART

Generally, the method of manufacturing a data carrier that can be use in a cellular phone or electronic device consists of manufacturing and testing a module. Said module comprising a lead frame with contacts on a first side and on a second side a dielectric substrate comprising an electronic chip connected to said lead frame by wires trough the dielectric substrate and protected by resin. Independently of the manufacturing of the module, an ISO card body, with at least one cavity to receive the module, is also manufactured by molding techniques well known by the one skilled in the art. The cavity could be formed during the molding of the card body or milled afterwards. The module is then embedded in the cavity, tested a second time and then the ISO card body is pre-cut in the desired SIM card format. Before use, the data carrier is separated from the ISO card body by the end user.

In this method of manufacturing a data carrier, all data carriers are manufactured in an ISO card body requiring more plastic materiel to manufacture it, increasing the costs.

In order to reduce the cost, it is known to manufacture a data carrier by molding a data carrier body directly around the electronic component like presented in the International patent application WO2004/036648. Another solution provided by the United States patent application US2007/0108298 consists of molding a casing layer, forming the data carrier body, under a lead frame of a module before the incorporation and connection of the electronic chip. A surface layer is thereafter laminated under the casing layer.

These methods of manufacturing are not satisfactory because they all have a molding step that requires molding device in the manufacturing process, increasing the time and the costs of production.

### SUMMARY OF THE INVENTION

An object of the invention, among others, is thus to improve a method of manufacturing a data carrier that can be use in a cellular phone or electronic device, in order to reduce its cost.

The present invention thus consists to a method of manufacturing a data carrier, comprising a data carrier body and a module fixed in a cavity in said data carrier body, said module comprising a lead frame with contacts on a first side and on a second side a dielectric substrate and also comprising an electronic chip connected to said lead frame by wires passing trough the dielectric substrate and protected by a dielectric resin, said method comprising the following steps:
a first step of providing a module,
a second step of applying a preformed first layer on the dielectric substrate of said module, said first layer having a hole to receive the electronic chip, its wires and the dielectric resin protection,
a third step of applying a second layer on the first layer, recovering the hole of the first layer,
a fourth step of laminating on the module, the first and second layers,
a fifth step of cutting or pre-cutting at the data carrier format.

According to one aspect of the invention, the method of manufacturing a data carrier includes an additional step of electrical and graphical personalization of the data carrier, after the fourth step of lamination and before the fifth step of cutting or pre-cutting.

According to another aspect of the invention, the module is provided on a support strip containing a plurality of modules.

According to another aspect of the invention, the hole goes through the complete thickness of the first layer.

According to another aspect of the invention, the support strip contains at least two modules on its width.

According to another aspect of the invention, the first layer is provided in roll format.

According to another aspect of the invention, the second layer is provided in roll format.

According to another aspect of the invention, fifth step is performed by laser cutting.

According to another aspect of the invention, the fifth step is performed by mechanical punching.

According to another aspect of the invention, the thickness of the data carrier is adjusted by the modulation of the thickness of the second layer.

### BRIEF DESCRIPTION OF THE DRAWINGS

The invention is explained in greater detail below with reference to the accompanying figures of which:

FIG. 1 shows a cross-section view of a data carrier according to the present invention,

FIG. 2 is a diagram illustrating the method of manufacturing a data carrier according to the present invention,

FIG. 3 illustrates a split view in perspective of a data carrier during its manufacture according to the present invention,

FIGS. 4a and 4b show perspective views of a data carrier during the last step of the method of manufacturing according to the present invention.

Same elements in different figures have the same references.

### DETAILED DESCRIPTION OF THE PREFERRED EMBODIMENT

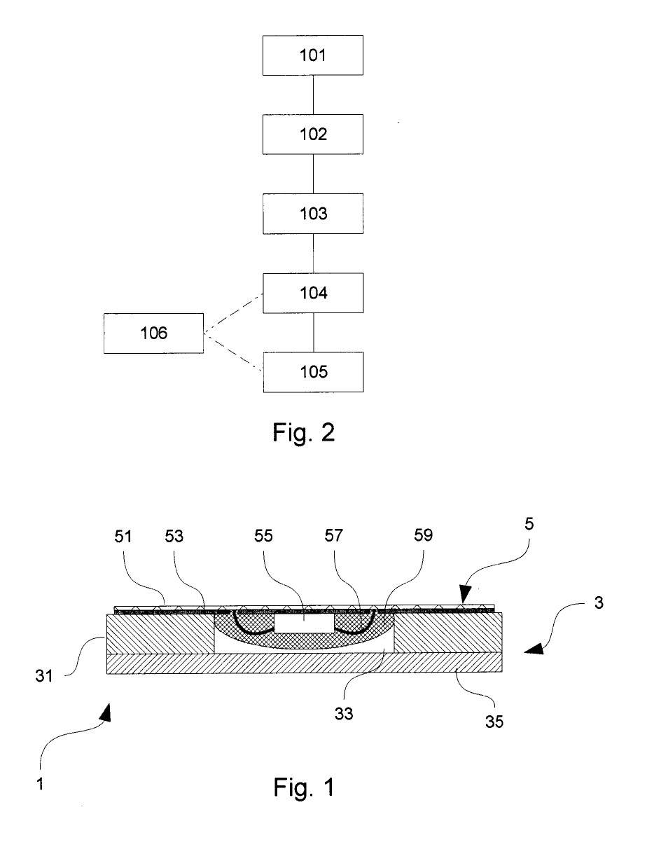

FIG. 1 shows a cross-section view of a data carrier 1. Said data carrier 1 comprises a module 5, said module 5 contains a lead frame 51 with contacts on a first side and on a second side a dielectric substrate 53. An electronic chip 55 is fixed on the dielectric substrate 53 and connected to the lead frame 51 by wires 57 passing through said dielectric substrate 53. The electronic chip 55 and its wires 57 are generally protected in a dielectric resin 59.

This module 5 is a standard module well known by the one skilled in the art.

The data carrier 1 also comprises a data carrier body 3 containing a first layer 31 and a second layer 35.

The first layer 31 is fixed on one of its side to the side of the module 5 containing the electronic chip 55. The first layer 31 also comprises a hole 33 to receive the electronic chip 55, its wires 57 and the dielectric resin protection 59. The hole 33 could go through the complete thickness of the first layer 31 or just deep enough to receive the electronic chip 55, its wires 57 and the dielectric resin protection 59 of the module 5.

The first layer 31 could also comprise a cavity (not represented) where the module 5 is placed so that the contacts of the lead frame 55 are on the same height as the surface of the first layer 31.

The second layer 35 is fixed on the other side of the first layer 31 and covers the hole 33.

The first and second layers 31, 35 are preferably made in a plastic material and their combined thicknesses added to the thickness of the lead frame 51 and the dielectric substrate 53 correspond to the thickness of the desired data carrier 1 format, like a 3ff plug or a 4ff plug. The adjustment to the desired data carrier 1 format thickness is obtained by the modulation of the thickness of the second layer 35.

The FIG. 2 shows a diagram illustrating the method of manufacturing a data carrier 1 as shown on FIG. 1 and below.

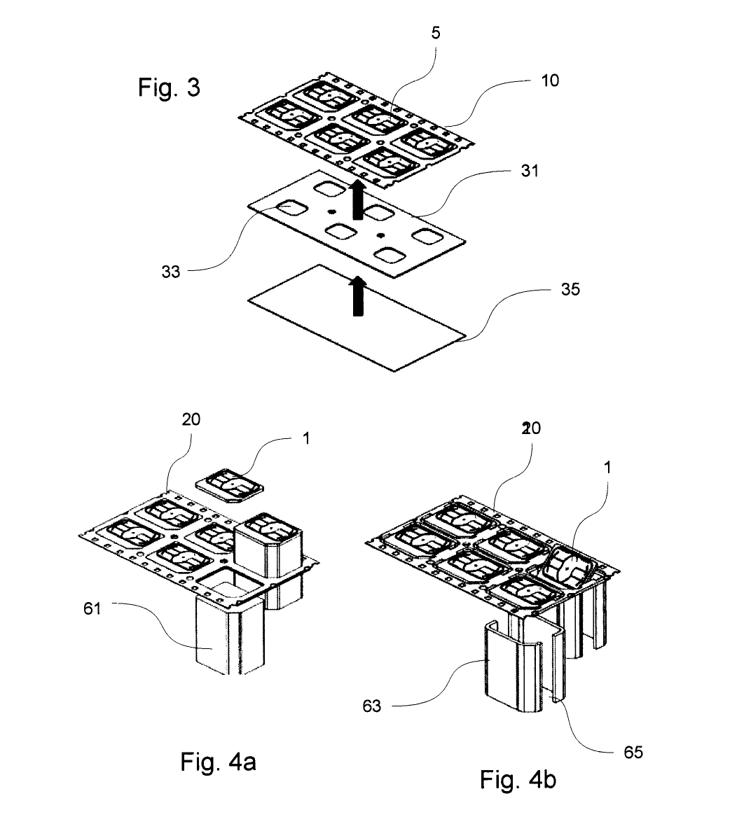

The method of manufacturing a data carrier 1 comprises a first step 101 of providing a module 5 as described above. The modules 5 could be provided on a support strip 10 like shown on FIG. 3. The support strip 10 could contain a plurality of module 5 and, as shown on FIGS. 3, the support strip 10 preferably contains two modules 5 on its width.

The second step 102 consists in applying the first layer 31 on the dielectric substrate 53 of the module 5. The electronic chip 55, its wires 57 and the dielectric resin protection 59 of the module 5 are here placed in the hole 33 of the first layer 31. The first layer is preformed before this second step 102 and advantageously, the first layer 31 is provided in a roll format. The first layer 31 could also be provided in other formats for example in a sheet format.

The third step 103 consists in applying the second layer 35 on the first layer 31, in order to cover the hole 33. As well as the first layer 31, the second layer 35 is advantageously provided in a roll format.

The fourth step 104 consists in a lamination step of the module 5 and the first and second layers 31, 35. During this step, pressure and/or temperature is applied to these three elements in order to join them together. As shown on FIG. 3, when the modules 5 are provided on a support strip 10, this fourth step 104 consists in laminating the strip 10 and the first and second layers 31, 35 together in order to join them and thus form a strip 20 containing these three layers.

The last and fifth step 105 consists in a cutting or precutting step of the data carrier 1 at the desired data carrier format. This step is illustrated on FIGS. 4a and 4b. In FIG. 4a, the strip 20 is cut by a mechanical punch 61 in order to extract completely a data carrier 1 from said strip 20. In FIG. 4b, the strip 20 is cut by a mechanical punch 63, comprising some openings 63, in order to precut the data carrier 1 on the strip 20 but keeping said data carrier 1 attached to said strip 20.

Other means like laser beam cutting can also be used to proceed to this fifth step 105.

The method of manufacturing a data carrier 1 could also comprise an additional step 106 of electrical and graphical personalization of the data carrier 1, after the fourth step 104 of lamination and before the fifth step 105 of cutting or pre-cutting. By electrical personalization, we understand the recording of data in the electronic chip 55.

This method of manufacturing a data carrier 1 is particularly adapted to the manufacture of 3ff or 4ff plug due to the thin space between the edge of the module 5 and the edge of the data carrier body 3 with these formats.

1. A method of manufacturing a data carrier (1), comprising a data carrier body (3) and a module (5) fixed above a cavity in said data carrier body (3), said module (5) comprising a lead frame (51) with contacts on a first side and on a second side a dielectric substrate (53) and also comprising an electronic chip (55) connected to said lead frame (51) by wires (57) passing trough the dielectric substrate (53) and protected by a dielectric resin (59), characterized in that said method comprises the following steps:
a first step (101) of providing a module (5),
a second step (102) of applying a preformed first layer (31) on the dielectric substrate (53) of said module (5), said first layer (31) having a hole (33) to receive the electronic chip (55), its wires (57) and the dielectric resin protection (59),
a third step (103) of applying a second layer (35) on the first layer (31), recovering the hole (33) of the first layer (35),
a fourth step (104) of laminating of the module (5), the first and second layers (31, 35),
a fifth step (105) of cutting or pre-cutting at the data carrier format.

2. A method according to claim 1, characterized in that it includes an additional step (106) of electrical and graphical personalization of the data carrier (1), after the fourth step (104) of lamination and before the fifth step (105) of cutting or pre-cutting.

3. A method according to claim 1, characterized in that the module (5) is provided on a support strip (10) containing a plurality of modules (5).

4. A method according to claim 1, characterized in that the hole (33) goes through the complete thickness of the first layer (31).

5. A method according to claim 3, characterized in that the support strip (10) contains at least two modules (5) on its width.

6. A method according to claim 1, characterized in that the first layer (31) is provided in roll format.

7. A method according to claim 1, characterized in that the second layer (35) is provided in roll format.

8. A method according to claim 1, characterized in that the fifth step (105) is performed by laser cutting.

9. A method according to claim 1, characterized in that the fifth step (105) is performed by mechanical punching.

10. A method according to claim 1, characterized in that the thickness of the data carrier (1) is adjusted by the modulation of the thickness of the second layer (35).
